(19) United States
(12) Patent Application Publication
(10) Pub. No.: US 2002/0192473 A1
(43) Pub. Date: Dec. 19, 2002

(54) Glazing provided with a stack of thin layers acting on solar radiation

(76) Inventors: Carole Gentilhomme, Aulnay Sous Bois (FR); Valerie Coustet, Montmorency (FR)

Correspondence Address: PENNIE & EDMONDS LLP, 1667 K STREET NW, SUITE 1000, WASHINGTON, DC, 20006

(21) Appl. No.: 10/094,967

(22) Filed: Mar. 12, 2002

Related U.S. Application Data
(63) Continuation of application No. PCT/FR00/02598, filed on Sep. 20, 2000.

(30) Foreign Application Priority Data
Sep. 23, 1999 (FR) FR99/11877

(51) Int. Cl. B32B 17/06

(52) U.S. Cl. 428/432; 428/433; 428/216; 359/359; 359/580

(57) ABSTRACT

The subject of the invention is a transparent substrate provided with a stack of thin layers acting on solar radiation, the stack including a functional layer made of metal (Nb, Ta, Zr) or the nitride of this metal, and an overlayer made of aluminum nitride or oxynitride and/or silicon nitride or oxynitride.

The invention relates to glazing provided with stacks of thin layers acting on solar radiation, especially glazing intended for thermal insulation and/or solar protection.

This type of glazing is more particularly suitable for fitting into buildings: by virtue of the thin layers, it makes it possible, by varying the amount of solar radiation energy, to prevent the interior of rooms being excessively heated in the summer and thus helps to limit the consumption of energy needed for air-conditioning them.

The invention also relates to this type of glazing once it has been opacified so as to form part of wall cladding panels, which is called, more concisely, “curtain walling” and which, in combination with window glazing, makes it possible to provide buildings with exterior surfaces that are entirely glazed.

Such multilayer glazing (and curtain walling) is subjected to a number of constraints: with regard to window glazing, the layers employed must filter out the solar radiation sufficiently. Furthermore, the thermal performance must preserve the optical and esthetic appearance of the glazing: it is desirable to be able to modulate the level of light transmission of the substrate and to retain an esthetically attractive color, most particularly in external reflection. This is also true of curtain walling with regard to the appearance in reflection. These layers must also be sufficiently durable this being the more so if, in the glazing once fitted, they are on one of the exterior faces of the glazing (as opposed to the “interior” faces turned toward the intermediate gas-filled cavity of a double-glazing unit, for example).

Another constraint is imposed progressively: when the glazing consists at least partly of glass substrates, these may have to undergo one or more heat treatments, for example a bending operation if it is desired to shape them (shopwindow) or a toughening or annealing operation if it is desired to make them stronger/less hazardous in the event of impacts. The fact that layers are deposited on the glass before its heat treatment means that there is a risk of them being damaged and their properties, especially optical properties, being substantially modified (to deposit the layers after the glass has been heat treated is complicated and expensive).

A first approach consists in modifying the optical appearance of the glass due to the layers after the heat treatment and in configuring the layers so that they have the desired properties, especially optical and thermal properties, only after this treatment. But in fact this means having to manufacture two types of multilayer stacks in parallel, one for non-toughened/non-curved glazing and the other for glazing which will be toughened/curved. It is endeavored henceforth to avoid this by devising stacks of thin (interferential) layers which are able to withstand heat treatments without the optical properties of the glass being modified too significantly and without its appearance being degraded (optical defects). The layers may then be referred to as “bendable” or “toughenable”.

An example of solar-protection glazing for buildings is given in patents EP-0 511 901 and EP-0 678 483: these refer to functional layers for filtering out solar radiation which are made of a nickel-chromium alloy, optionally nitrided, made of stainless steel or of tantalum and are placed between two dielectric layers of metal oxide such as SnO₂, TiO₂ or Ta₂O₅. Such glazing makes for good solar-protection glazing with satisfactory mechanical and chemical durability, but is not truly “bendable” or “toughenable” since the oxide layers surrounding the functional layer do not prevent it from being oxidized during the bending or toughening operation, the oxidation being accompanied by a modification in the light transmission and in the general appearance of the glazing in its entirety.

Many studies have been carried out recently to make the layers bendable/toughenable in the context of low-emissivity glazing, in which the aim is rather to achieve high light transmission as opposed to solar protection. It has already been proposed to use above the silver functional layers dielectric layers based on silicon nitride, this material being relatively inert with respect to high-temperature oxidation and proving suitable for preserving the subjacent silver layer, as described in patent EP-0 718 250.

Other multilayer stacks acting on solar radiation and assumed to be bendable/toughenable have been described, these employing functional layers other than silver: patent EP-0 536 607 uses functional layers made of a metal nitride, of the TiN or CrN type, with protective layers made of metal or of silicon derivatives; patent EP-0 747 329 describes functional layers made of a nickel alloy of the NiCr type which are combined with silicon nitride layers.

However, the performance of these stacks providing a solar protection function are still capable of improvement, especially in terms of durability and of resistance to degradation when subjected to a high-temperature heat treatment.

The term “functional” layer is understood to mean in the present invention the layer(s) in the stack which gives the latter most of its thermal properties, as opposed to the other layers, generally made of dielectric material, having as function that of chemically or mechanically protecting the functional layers, an optical function, an adhesion layer function, etc.

The object of the invention is therefore to develop a novel type of stack of thin layers acting on solar radiation, for the purpose of manufacturing improved solar-protection glazing. The intended improvement is especially to obtain a better compromise between durability, thermal properties, optical properties and ability to withstand heat treatments without any damage when the substrate carrying the stack is of the glass type.

The other object of the invention is to make this multilayer stack compatible with the use of the glazing, once it has been opacified, as curtain walling.

The subject of the invention is first of all a transparent substrate, especially made of glass, provided with a stack of thin layers acting on solar radiation, which stack includes at least one functional layer of essentially metallic nature and predominantly comprising at least one of the metals belonging to the group consisting of niobium, tantalum and zirconium, said functional layer being surmounted by at least one overlayer which is based on silicon nitride or oxynitride or based on aluminum nitride or oxynitride or on a mixture of at least two of these compounds (Si—Al mixed nitrides or oxynitrides).

Alternatively, the functional layer according to the invention may be based on a partially or entirely nitrided metal, said metal belonging to the group consisting of niobium, tantalum and zirconium.

The combination of these types of functional layer and of these types of overlayer proves to be extremely advantageous for solar-protection glazing: the functional layers of the Nb, Ta or Zr type are particularly stable and, independently of the nature of the overlayer, are themselves more appropriate than other functional layers already used in the same type of application for withstanding various heat treatments. It has in fact been demonstrated that, for example, niobium tends to oxidize less than other metals, such as titanium or nickel, and that the selected metals are also more stable than Ni—Cr alloys containing a significant amount of chromium, since chromium has a tendency to diffuse under the effect of heat into the adjacent layers and the adjacent glass and consequently to optically change the multilayer stack in its entirety. The functional layers of the nitride type, most particularly niobium nitride, are also chemically very stable.

Furthermore, the functional layers of the invention make it possible to vary, within the desired ranges specified below, the light transmission value of the substrate by adjusting their thicknesses, while still retaining an appreciable solar-protection effect, even with a relatively high light transmission: in a word, they are sufficiently selective, making it possible, in particular, to achieve good compromises between the level of light transmission (T_{L}) and solar factor (SF) (the solar factor is defined as the ratio of the total energy entering a room through the glazing to the incident solar energy). A “good” compromise may be defined as being when the T_{L} and SF values of solar-protection glazing are similar to each other, for example with an SF of at most 5 to 10% higher than T_{L}, especially at most 2 to 3% higher than T_{L}. This compromise may also be expressed by comparing the T_{L} value with the value of the energy transmission T_{E}, a “good” compromise being obtained when the T_{E} value is close to that of T_{L}, for example to within about 5%, especially about 2 to 3%, of that of T_{L}. The choice of an overlayer based on silicon nitride or aluminum nitride (these being abbreviated to Si₃N₄ and AlN) or on silicon oxynitride or aluminum oxynitride (these being abbreviated to SiON and AlNO, without prejudicing the respective amounts of Si, O and N) has also proved to be highly advantageous on several counts: this type of material proves to be capable of protecting the functional layers of the invention at high temperature, especially with respect to oxidation, while maintaining their integrity, thereby making the stack according to the invention bendable/toughenable when the substrate carrying the stack is made of glass and when it is desired for said stack to undergo a heat treatment of this type after deposition of the layers: the change in optical properties caused by a heat treatment of the toughening type is slight, with the light transmission and external appearance in reflection both being modified sufficiently slightly not to be significantly perceptible to the human eye.

Furthermore, its refractive index, close to 2, is similar to that of metal oxides of the SnO₂ or ZnO type: optically, it is similar to the latter, without any particular complication. It also provides the correct mechanical and chemical protection of the rest of the stack.

Finally, it has been discovered that it is also compatible with a subsequent enameling treatment, this being most particularly advantageous in the case of curtain walling, since in general there are two possible ways of opacifying the glazing for curtain walling: either a lacquer is deposited on the glass, which is dried and cured with a moderate heat treatment, or an enamel is deposited. The enamel, like that usually deposited, is composed of a powder containing a glass frit (the glassy matrix) and pigments used as colorants (the frit and the pigments being based on metal oxides), and a medium also called a vehicle, allowing the powder to be applied to the glass and to adhere to it at the time of deposition. To obtain the final enameled coating, it must then be fired, and this firing operation is frequently carried out concomitantly with the operation of toughening/bending the glass. Reference may be made for further details about the enamel compositions to patents FR-2 736 348, WO 96/41773, EP-718 248, EP-712 813 and EP-636 588. The enamel, a mineral coating, is durable, adherent to the glass and therefore a useful opacifying coating. However, when the glazing is provided beforehand with thin layers, it is tricky to use it for two reasons:

on the one hand, firing the enamel necessarily means subjecting the multilayer stack to a high-temperature heat treatment, which is possible only if the stack is capable of not being optically degraded during this treatment; and

on the other hand, over time the enamel tends to release chemical substances which diffuse into the subjacent layers and chemically modify them.

However, using a layer of silicon nitride or oxynitride or aluminum nitride or oxynitride to complete the stack of thin layers has been very effective both for making the overall stack capable of withstanding the heat treatments and for acting as a barrier to these chemical compounds liable to diffuse out of the enamel layer. Consequently, the multilayer stack according to the invention is enamelable in the sense that an enamel can be deposited on the stack and fired without appreciably changing the optical appearance, with respect to window glazing provided with the same layers, in external reflection. This is precisely the challenge for curtain walling, namely to provide harmony of color and as far as possible similarity of external appearance with the window glazing so as to be able to form entirely glazed walls which are esthetically attractive.

There is also another advantage in combining the functional layers with the overlayer according to the invention: although Si₃N₄, SiON, AlN and AlNO have the very useful properties mentioned above, they also have a tendency to cause problems of adhesion to many metal layers. This is especially the case with silver layers. It is then necessary to use means to increase this adhesion and prevent the stack from delaminating: in particular, adhesion layers may be interposed, for example thin layers of metal or layers based on zinc oxide, exhibiting good compatibility between the two materials in question. The presence of these adhesion layers is unnecessary within the context of the invention. Thus, it has been confirmed that the functional layers of the invention, especially Nb layers, adhere very satisfactorily to the Si₃N₄, SiON, AlN and AlNO layers, using a sputtering deposition technique, especially magnetic-field-enhanced sputtering.

Optionally, the multilayer stack according to the invention may also include, between the substrate and the functional layer, at least one sublayer made of a transparent dielectric material, especially one chosen, like for the overlayer, from silicon nitride or oxynitride and/or aluminum nitride or oxynitride, or even silicon oxide SiO₂.

This sublayer can allow the optical appearance conferred by the multilayer stack on its carrier substrate to be varied with greater flexibility. Furthermore, in the case of a heat treatment, it forms an additional barrier, especially with respect to oxygen and alkali metals of the glass substrate, which species are liable to migrate with heat and degrade the stack.

A preferred embodiment consists in using an overlayer and a sublayer which are both made of nitride or oxynitride, especially both based on silicon nitride.

It has proven advantageous, in this case, according to one embodiment, to make the overlayer thicker than the sublayer, for example by a factor of at least 1.2 or 1.5 or 1.8: it may even have a thickness 2, 3 or 4 times greater (the thickness in question being the geometrical thickness) since it has been demonstrated in the present invention that thicker overlayers ensure better optical stability with respect to heat treatments of the toughening type.

According to another embodiment, not exclusive of the previous one, provision may be made to use multiple sublayers, especially having an alternation of high refractive index (for example between 1.8 and 2.2) and low refractive index (for example between 1.4 and 1.6). These are preferably sequences of the Si₃N₄ (index≈2)/SiO₂ (index≈1.45) or Si₃N₄/SiO₂/Si₃N₄ type. These sequences allow the external appearance of the substrate in reflection to be adjusted, especially for the purpose of reducing the value of R_{L} and/or its color.

The multilayer stack according to the invention may also include, optionally, above and/or below the functional layer, an additional layer of a nitride of at least one metal chosen from niobium, titanium, zirconium and chromium. In fact, it can therefore be interposed between the functional layer and the overlayer and/or between the functional layer and the substrate (or between the functional layer and the sublayer when there is one). When the functional layer is itself a nitride, there may therefore be the superposition of two nitride layers based on different metals.

This additional nitride layer has proven capable of more finely adjusting the color of the stack in external reflection by reducing the thickness of the functional layer that it allows: thus it is possible to “replace” part of the thickness of the functional layer with this additional layer.

Advantageously, the layer or layers of the stack which are based on silicon nitride or oxynitride also contain a metal in a minor amount with respect to silicon, for example aluminum, especially up to 10% by weight of the compound constituting the layer in question. This is useful for increasing the rate of deposition of the layer by magnetic-field-enhanced and reactive sputtering, in which the silicon target without any “doping” with a metal is not conducting enough. The metal may furthermore confer better durability on the nitride or oxynitride.

With regard to the thicknesses of the layers described above, it is usual to choose a thickness range from 5 to 50 nm for the functional layer, especially between 8 and 40 nm. The choice of its thickness allows the light transmission of the substrate to be varied within ranges used for glazing providing buildings with solar protection, i.e. especially 5 to 50% or 8 to 45%. Of course, the light transmission level may also be modified using other parameters, especially the thickness and the composition of the substrate, most particularly when it is made of clear or colored glass.

The thickness of the overlayer is preferably between 5 and 70 nm, especially between 10 and 35 nm. For example, it is 15, 20 or 30 nm.

The thickness of the optional sublayer is preferably between 5 and 120 nm, especially between 7 and 90 nm.

When there is a single sublayer, of the Si₃N₄ type, its thickness, is, for example, 5 to 30 nm, especially about 10 to 15 or 20 nm. When it is a sequence of several layers, each of the layers may have a thickness of, for example, 5 to 50 nm, especially 15 to 45 nm.

The sublayer and/or the overlayer may in fact form part of a superposition of dielectric layers. One or other may thus be combined with other layers of different refractive indices. Thus, the multilayer stack may include, between the substrate and the functional layer (or above the functional layer) an alternation of three, high index/low index/high index, layers, the “high index” (at least 1.8 to 2) layer or one of them possibly being the sublayer of the invention of the Si₃N₄ or AlN type and the “low index” (for example less than 1.7) layer possibly being made of silicon oxide SiO₂.

The thickness of the additional metal nitride layer is preferably between 2 and 20 nm, especially between 5 and 10 nm. It is therefore preferably thin and therefore possibly contributes only very slightly to the solar protection effect imparted by the metal layer.

A preferred embodiment of the invention is a stack comprising a functional layer based on niobium or on niobium nitride, an overlayer based on silicon nitride and an optional sublayer also based on silicon nitride.

The subject of the invention is also a substrate provided with the multilayer stack which is described above, in general, and is bendable and/or toughenable and/or enamelable. A stack which is “bendable and/or toughenable” is understood within the meaning of the invention to be a stack which, deposited on the substrate, undergoes a limited optical change and may especially be quantified within the (L*,a*,b*) colorimetry system by a ΔE value of less than 3, especially less than 2.

ΔE is defined as follows:

ΔE=(ΔL^{*2}+Δa^{*2}+Δb^{*2})^{½}, where ΔL*, Δa* and Δb* are the differences in the L*, a* and b* measurements before and after heat treatment.

The stack is considered as “enamelable” when it is possible to deposit on it, in a known manner, an enamel composition without the appearance of optical defects in the stack and with a limited optical change, which may be quantified as above. This also means that it has a satisfactory durability, without any undesirable deterioration of the layers of the stack in contact with the enamel, either while it is being fired or over time once the glazing has been fitted.

Of course, a stack of this type is advantageous when substrates made of clear or bulk-tinted glass are used. However, it is possible just as well not to seek to exploit its bendable/toughenable nature but simply its satisfactory durability, by using glass substrates but also substrates not made of glass, especially made of a rigid and transparent polymer material such as polycarbonate or polymethyl methacrylate (PMMA) substituting for the glass, or else a flexible polymer material, like certain polyurethanes or like polyethylene terephthalate (PET), which flexible material can then be fastened to a rigid substrate in order to functionalize it, by making them adhere by various means, or by a lamination operation.

The subject of the invention is also “monolithic” glazing (i.e. glazing comprising a single substrate) or insulating multiple glazing of the double-glazing type. Preferably, whether monolithic glazing or double glazing, the multilayer stacks are placed on the 2 face (conventionally, the glass/substrate faces of a glazing assembly are numbered from the outside toward the inside of the compartment/room which is fitted therewith) and provide a solar radiation protection effect.

More particularly, advantageous glazing according to the invention has a T_{L} of about 5 to 55%, especially 8 to 45%, and a solar factor SF of less than 50%, especially close to the T_{L} value. It also has preferably a blue or green color in external reflection (on that side of the substrate which is not provided with layers) especially with, in the (L*,a*,b*) colorimetry system, negative a* and b* values (before and after any possible heat treatment). Thus, an attractive and not very strong color in reflection, desirable in buildings, is obtained.

The subject of the invention is also a substrate with a multilayer stack and partially opacified by a coating of the lacquer or enamel type, for the purpose of making curtain walling, in which the opacifying coating is in direct contact with the multilayer stack. The multilayer stack can therefore be absolutely identical for window glazing and for curtain walling.

Although the application more particularly intended by the invention is glazing for buildings, it is clear that other applications can be envisaged, especially for vehicle windows (apart from windshields, in which a very high light transmission is required), such as the side windows, sunroof and rear window.

The invention will be described below in greater detail with the aid of nonlimiting examples.

All the substrates are made of 6 mm thick clear glass of the PLANILUX type sold by Saint-Gobain Vitrage.

All the layers are deposited in a known manner by magnetic-field-enhanced sputtering, the metal layers using a metal target in an inert atmosphere (100% Ar), the metal nitride or silicon nitride layers using a suitable metal or silicon (bulk-doped with 8% aluminum) target in a reactive atmosphere containing nitrogen (100% N₂ for TiN and 40% Ar/60% N₂ for Si₃N₄). The Si₃N₄ layers therefore contain a little aluminum.

### EXAMPLE 1

This example uses an Nb functional layer and an Si₃N₄ overlayer according to the following sequence:

glass/Nb (30 nm)/Si₃N₄ (31 nm).

After depositing the layers, the substrate underwent the following heat treatment: 620° C. heating for 10 minutes.

### EXAMPLE 2

This example uses the same functional layer and the same overlayer as in Example 1, with an additional Si₃N₄ sublayer according to the following sequence:

glass/Si₃N₄ (10 nm)/Nb (30 nm)/Si₃N₄ (31 nm).

The coated substrate then underwent the same heat treatment as in Example 1.

### EXAMPLE 3

This example uses the same sequence of layers as in Example 2, but with slight changes in their thicknesses:

glass/Si₃N₄ (10 nm)/Nb (33 nm)/Si₃N₄ (27 nm).

After the layers have been deposited, the substrate underwent an enameling operation on its face coated with the multilayer stack. The enamel composition was standard, for example of the type described in an aforementioned patent, such as FR-2 736 348, and the enameling was carried out in a known manner with a heat treatment to cure the enamel at about 620° C.

### EXAMPLE 4

This example repeats the sequence of layers in Examples 2 and 3, but with a smaller thickness of the functional layer, intended for glazing with a higher light transmission:

glass/Si₃N₄ (10 nm)/Nb (12 nm)/Si₃N₄ (17 nm).

The coated substrate then underwent the same heat treatment as in Example 1.

### EXAMPLE 5

This example repeats the sequence of layers in Example 4, but by “replacing” part of the thickness of the Nb functional layer with an additional TiN layer between the latter and the overlayer.

The sequence of layers was as follows:

glass/Si₃N₄ (10 nm)/Nb (8 nm)/TiN (5 nm)/Si₃N₄ (17 nm).

The coated substrate then underwent the same heat treatment as in Example 1.

### EXAMPLE 6

This example illustrates another embodiment of the invention in which the functional layer is made of a metal nitride, in this case niobium nitride.

The sequence of layers was as follows:

glass/Si₃N₄ (10 nm)/NbN (10 nm)/Si₃N₄ (15 nm).

The Si₃N₄ layers were obtained as previously and the NbN layer was obtained using a niobium target in a reactive atmosphere containing 30% nitrogen by volume.

### COMPARATIVE EXAMPLE 1

This example serves for comparison with Example 1: instead of an Nb functional layer, a functional layer made of a 40/60 by weight NiCr alloy was used. The sequence of layers was as follows:

glass/NiCr (30 nm)/Si₃N₄ (27 nm).

The coated glass then underwent the same treatment as in Example 1.

### COMPARATIVE EXAMPLE 2

This example serves for comparison with Example 2: it uses a functional layer made of 40/60 by weight NiCr instead of an Nb functional layer.

The sequence of layers was as follows:

glass/Si₃N₄ (10 nm)/NiCr (30 nm)/Si₃N₄ (27 nm).

The coated substrate then underwent the same heat treatment as in Example 1.

Table 1 below combines, for Examples 1, 2 and Comparative Examples 1 and 2, the following properties:

transmission:

optical transmission T₁=: light transmission in % under illuminant D₆₅;

λd_{(T)}: the dominant wavelength in nm of the color in transmission;

Pe_{(T)}: the excitation purity, in %, of the color in transmission.

external reflection (i.e. that measured on the external side when the coated glass is fitted as monolithic glazing in a room with the multilayer stack on the 2 face:

external reflection (R_{LEXT}) in %;

a* _{(REXT)}, b*_{(REXT)}, the calorimetric coordinates in external reflection according to the (L,a*,b*) colorimetry system;

internal reflection:

the value of R_{LINT} in % and the calorimetric data a*_{(RINT)},

b*_{(RINT)},

energy transmission:

T_{E} in %.

All these properties are given twice: once before heat treatment and once after heat treatment. Also measured are ΔE_{(T)} in transmission, ΔE_{(REXT)} in external reflection and ΔE_{(RINT)} in internal reflection, where ΔE=(ΔL^{*2}+Δa^{*2}+Δb^{*2})^{½} for transmission, with:

Δa*=a* (after treatment)−a* (before treatment);

Δb*=b* (after treatment)−b* (before treatment);

ΔL*=L* (after treatment)−L* (before treatment).

TABLE 1

| | Heat | TRANSMISSION | | | | EXTERNAL REFLECTION | | | | INTERNAL REFLECTION | | | | |
|---|---|---|---|---|---|---|---|---|---|---|---|---|---|---|
| EXAMPLE | treatment | T_{L} | λd_{(T)} | Pe_{(T)} | ΔE_{(T)} | R_{LEXT} | a* _{(REXT} | b* _{(REXT)} | ΔE_{(REXT)} | R_{LINT} | a* _{(RINT)} | b*_{(RINT)} | ΔE_{(RINT)} | T_{E} |
| Comparative | Before | 11.5 | 479 | 7.7 | — | 43.0 | −1.8 | −1.0 | — | 32.7 | 0.7 | 21.6 | — | 10.2 |
| Example 1 | After | 18.8 | 481 | 9.7 | 10.1 | 34.8 | −1.9 | 1.7 | 6.5 | 25.9 | 2.1 | 13.7 | 10.1 | 15.5 |
| Comparative | Before | 12.4 | 479 | 9 | — | 42 | −2 | 0.3 | — | 30.5 | 1.1 | 24.5 | — | 10.7 |
| Example 2 | After | 10.6 | 477 | 13.1 | 2.3 | 43.2 | −1.8 | 1.5 | 1.5 | 38.2 | 0.2 | 19.9 | 7.7 | 9.1 |
| Example 1 | Before | 10.2 | 572 | 2.3 | — | 45.5 | −2.7 | −1.8 | — | 31.3 | 0.1 | 18.7 | — | 9.0 |
| | After | 9 | 544 | 1 | 2.2 | 46.6 | −2.1 | −0.5 | 1.6 | 35.7 | 0.6 | 16.0 | 2.7 | 8.2 |
| Example 2 | Before | 12.5 | 500 | 0.3 | — | 41.8 | −2.5 | −1.4 | — | 30 | 0.1 | 17.6 | — | 11.3 |
| | After | 11.4 | 566 | 0.8 | 1.7 | 42.2 | −2.7 | −1.4 | 0.3 | 32.1 | 0.2 | 18.1 | 1.8 | 10.3 |

This table shows that Examples 1 and 2 according to the invention provide a good T_{L}/T_{E} compromise before heat treatment, with similar T_{L} and T_{E} values: they provide good solar protection. They are also good from the point of view of esthetic appearance, most particularly in the external reflection where the a* and b* values are negative and, in absolute values, not very high, at most 2.7: this is not a very strong color and is in the blue-green, regarded as attractive or glazing with strong external reflection.

What is notable is that all these advantages are retained after heat treatment: the T_{L} and T_{E} values are retained to within 1%, the calorimetric data change very little and there is no switch from one color to another in external reflection. There are no optical defects, the ΔE value, quantifying a possible calorimetric change, remains at most 2.7 in transmission, in internal reflection and in external reflection, with a ΔE of only 1.6 in external reflection: this is indeed a stack capable of undergoing a treatment of the bending or toughening type without significant degradation. Whether it is desired to have a glass which may or may not be toughened, annealed or curved, the invention provides a solar-protection stack with identical, retained, properties. The comments made with regard to Example 1 also apply to Example 2, with an even smaller optical change: in particular, a ΔE of only 0.3 in external reflection.

It may be seen that it is advantageous to provide an Si₃N₄ overlayer with a thickness of at least 5 to 15 or 20 nm more than the thickness of the Si₃N₄ sublayer: this results in a gain in toughenability, while retaining a satisfactory appearance in reflection.

The results for Comparative Examples 1 and 2 are significantly inferior: these stacks are clearly not bendable/toughenable within the meaning of the invention: the T_{L} and T_{E} values change greatly. Thus, in Comparative Example 1, T_{L} goes from 11.5% to almost 20%. The ΔE values in internal reflection and external reflection for Comparative Example 1 are at least three times greater than those obtained according to the invention and the sign of b* changes in external reflection: there is a color change. This confirms the fact that it is preferable to omit or limit as far as possible the presence of chromium in the functional layers (for example at most 20%, especially at most 10 or at most 5%, by weight), chromium having, because of its propensity to diffuse at high temperature, probably a role in these changes.

Table 2 below gives the parameters already explained in the case of Table 1 with regard to Example 3 in which an enamel has been deposited on the layers: the R_{LEXT}, a*_{(REXT)} and b*_{(REXT)} values were measured before and after enameling (the same fitting of the glazing, now curtain walling, as in Table 1, namely monolithic glass with layers and enamel on the 2 face).

TABLE 2

| Example | | TRANSMISSION | | | EXTERNAL REFLECTION | | | | INTERNAL REFLECTION | | |
|---|---|---|---|---|---|---|---|---|---|---|---|
| 3 | Enameling | T_{L} | λd_{(T)} | Pe_{(T)} | R_{LEXT} | a*_{(REXT)} | b*_{(REXT)} | ΔE | R_{LINT} | a*_{(RINT)} | b*_{(RINT)} |

| | | | | | | | | | | |
|---|---|---|---|---|---|---|---|---|---|---|
| Before | 7.7 | 565 | 2.4 | 43.6 | −3.2 | 1.1 | — | 35.5 | 0.5 | 18.4 |
| After | — | — | — | 43.7 | −2.5 | 2.8 | 1.0 | — | — | — |

It is verified that the color remains approximately the same in external reflection after enameling with a ΔE of the order of 1. Nor is the aging of the curtain walling significantly greater than in the case of standard curtain walling, with the same enamel deposited directly on the glass.

Table 3 below combines the parameters, already explained above, for Examples 4 and 6 (the same configuration of monolithic glass with layers on the 2 face).

TABLE 3

| | | | | | EXTERIOR | | | | INTERNAL | | | |
|---|---|---|---|---|---|---|---|---|---|---|---|---|
| | TRANSMISSION | | | | REFLECTION | | | | REFLECTION | | | |
| | | λd | | | | | | | | | | |
| | T_{L} (%) | (nm) | Pe (%) | ΔE_{(T)} | R_{LEXT} | a* | b* | ΔE_{(R)} | R_{LINT} | a* | b* | T_{E} |
| Example 4 | 32.3 | 541 | 0.6 | 2.7 | 14.4 | −1.7 | −4.8 | 3.3 | 25.3 | −0.3 | 1.2 | 31.0 |
| Example 5 | 30.6 | 535 | 1.4 | 2.3 | 16.6 | −1.7 | −7.2 | 2.5 | 27.7 | −1.7 | 1.6 | 27.6 |
| Example 6 | 31.2 | 483 | 4.2 | 1.2 | 17.9 | −0.4 | −3.5 | 1.4 | 27.8 | 0.7 | 3.1 | 30.0 |

The advantages of inserting an additional TiN layer are thus demonstrated: it is more difficult to achieve low ΔE values, especially values of less than 2, in glazing with a multilayer stack having relatively high light transmission values, in this case about 30%, whereas the light transmission was about 8% for the previous examples. But by adding the TiN layer (Example 6), it is possible to make the ΔE value go below the 2 threshold. The TiN therefore has both a role of colorimetric adjustment per se and a role of stabilizing the appearance in external reflection for glazing with a multilayer stack having a T_{L} particularly greater than 20%.

Examples 7 to 9 below were produced, especially for the purpose of better adjusting the color of the glazing in external reflection.

### EXAMPLE 7

This example uses a niobium nitride functional layer and two sublayers, namely an Si₃N₄ layer (refractive index from about 2) followed by an SiO₂ layer (refractive index of about 1.45).

The sequence was as follows:

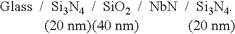

The thickness of the NbN layer was adjusted so as to obtain a light transmission of 32%.

### EXAMPLE 8

This example is similar to Example 7, but the NbN layer is replaced by a Nb metal layer (with a thickness such that, again, the light transmission is 32%).

The sequence was therefore:

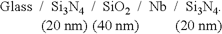

### EXAMPLE 9

This example is similar to Example 8, but using a triple sublayer, namely a high-index layer, a low-index layer and then a high-index layer again.

The sequence was as follows:

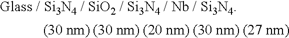

The thickness of the Nb layer was adjusted so as to have a T_{L} of about 8%.

Table 4 below gives, for Examples 7 and 8, the same photometric properties in transmission and in external reflection as those already given in Table 1.

TABLE 4

| | HEAT | TRANSMISSION | | | | EXTERNAL REFLECTION | | | |
|---|---|---|---|---|---|---|---|---|---|
| EXAMPLE | TREATMENT | T_{L}(%) | λd (nm) | Pe (%) | ΔE_{(T)} | R_{LEXT} | a*_{REXT} | b*_{REXT} | ΔE_{(R)} |
| Ex.7 | before | 32.3 | 489 | 2.3 | — | 15.3 | 1.7 | −10.3 | — |
| | after | 31.8 | 484 | 4.3 | 1.7 | 15.7 | 1.7 | −9.1 | 2.0 |
| Ex.8 | before | 32.2 | 572 | 3.7 | — | 13.3 | 1.0 | −15.0 | — |
| | after | 30.7 | 563 | 2.1 | 2.4 | 15.4 | 0.9 | −11.8 | 4.3 |

Example 10 below uses a tantalum functional layer.

### EXAMPLE 10

This example uses the following sequence of layers:

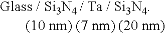

Table 5 below gives, for this example, the same information as that given in Table 4.

TABLE 5

| | HEAT | TRANSMISSION | | | | EXTERIOR REFLECTION | | | |
|---|---|---|---|---|---|---|---|---|---|
| EXAMPLE | TREATMENT | T_{L} (%) | λd (nm) | Pe (%) | ΔE_{(T)} | R_{LEXT} | a*_{REXT} | b*_{REXT} | ΔE_{(R)} |
| Ex.10 | before | 32.6 | 480 | 3.4 | — | 19 | −0.7 | −3.9 | — |
| | after | 32.9 | 482 | 3.0 | 1.2 | 18.5 | −1.2 | −3.7 | 0.9 |

This stack containing tantalum therefore shows that the optical changes after toughening are limited, these being similar to those obtained with NbN layers in particular. The same advantage is obtained using, this time, tantalum nitride.

It may also be envisaged to use, as functional layer, molybdenum which makes it possible to obtain a bluer color in external reflection.

In conclusion, the solar-protection glazing according to the invention is highly advantageous for fitting into buildings, but not to the exclusion of applications in automobiles and any other vehicle: side windows, rear window and sunroof, which may also have enameled coatings. With a fixed multilayer stack, especially with the desired T_{L} and T_{E} values, it is thus possible, without having to modify the stack, to manufacture window glazing which is not intended to undergo heat treatments or which must be bent/toughened/annealed and to manufacture curtain walling in complete calorimetric harmony with the window glazing, which may be lacquered or enameled: it is thus possible to standardize the manufacture of interferential layers on large-sized substrates, this being a great advantage from the industrial standpoint.

The invention has resulted in the development of toughenable solar control glazing with ΔE values in external reflection of less than or equal to 2, or even 1.8, which is remarkable.

It is also possible to make enameled, rather than lacquered, multilayer-coated curtain walling, this also being highly advantageous from an industrial standpoint (enameling taking place during the toughening process whereas lacquering requires an additional manufacturing step).

1. A transparent substrate, provided with a stack of thin layers acting on solar radiation, characterized in that said stack includes at least one functional layer of essentially metallic nature and predominantly comprising at least one of the metals belonging to the group consisting of niobium, tantalum and zirconium, said functional layer being surmounted by at least one overlayer based on aluminum nitride, aluminum oxynitride, silicon nitride or silicon oxynitride, or on a mixture of at least two of these compounds.

2. A transparent substrate, provided with a stack of thin layers acting on solar ration, characterized in that said stack includes at least one functional layer based on a partially or entirely nitrided metal, said metal belonging to the group consisting of niobium, tantalum and zirconium, said functional layer being surmounted by at least one overlayer based on aluminum nitride or oxynitride, silicon nitride or oxynitride or on a mixture of at least two of these compounds.

3. The substrate as claimed in claim 1 or 2, characterized in that the stack also includes, between the substrate and the functional layer, at least one sublayer made of transparent dielectric material, especially one chosen from silicon nitride and/or aluminum nitride, silicon oxynitride and/or aluminum oxynitride and silicon oxide.

4. The substrate as claimed in claim 3, characterized in that the stack includes an overlayer based on a nitride or oxynitride and a sublayer based on a nitride or oxynitride, the geometrical thickness of the overlayer being greater than that of the sublayer.

5. The substrate as claimed in claim 4, characterized in that said overlayer and said sublayer are based on silicon nitride.

6. The substrate as claimed in claim 4 or claim 5, characterized in that the overlayer is thicker than the sublayer by a factor of at least 1.2, especially by a factor of at least 1.5 to 1.8.

7. The substrate as claimed in one of the preceding claims, characterized in that the stack includes a plurality of sublayers between the substrate and the functional layer, especially an alternation of high-index and low-index layers such as Si₃N₄/SiO₂ or Si₃N₄/SiO₂/Si₃N₄.

8. The substrate as claimed in one of the preceding claims, characterized in that the stack also includes an additional layer of a nitride of at least one metal chosen from niobium, titanium and zirconium between the functional layer and the overlayer and/or between the functional layer and the substrate.

9. The substrate as claimed in one of the preceding claims, characterized in that the functional layer has a thickness of between 5 and 50 nm, especially between 8 and 40 nm.

10. The substrate as claimed in one of the preceding claims, characterized in that the thickness of the overlayer is between 5 and 120 nm, especially between 7 and 90 nm.

11. The substrate as claimed in claim 8, characterized in that the additional metal nitride layer has a thickness of between 2 and 20 nm, especially between 5 and 10 nm.

12. The substrate as claimed in one of the preceding claims, characterized in that the stack uses a functional layer of niobium or tantalum, an overlayer of silicon nitride, an optional sublayer also of silicon nitride and an optional layer of titanium nitride or niobium nitride directly on or directly under the functional layer.

13. The substrate as claimed in one of claims 1 to 11, characterized in that the stack uses a functional layer of niobium nitride, an overlayer of silicon nitride, and an optional sublayer also of silicon nitride.

14. The substrate as claimed in one of the preceding claims, characterized in that it is bendable/toughenable and/or enamelable.

15. The substrate as claimed in one of the preceding claims, characterized in that it is made of clear or bulk-tinted glass, or of a flexible or rigid transparent polymer material.

16. Monolithic glazing or double glazing incorporating the substrate as claimed in one of the preceding claims, the multilayer stack preferably being on the 2 face, numbering the substrate faces from the outside toward the inside of the compartment/room which is fitted therewith, giving the glazing a solar radiation protection effect.

17. The glazing as claimed in claim 15, characterized in that it has a light transmission T_{L} of 5 to 55%, especially 8 to 45%, and a solar factor SF of less than 50%, especially close to the light transmission value.

18. The glazing as claimed in claim 16 or 17, characterized in that it is blue or green in external reflection, on the substrate side, with, in particular, negative a* and b* values.

19. The substrate as claimed in one of claims 1 to 15, characterized in that it is at least partially opacified by a coating in the form of a lacquer or an enamel.

20. A wall cladding panel, of the curtain-walling type, incorporating the opacified substrate as claimed in claim 19.
